(19) United States
(12) Patent Application Publication
(10) Pub. No.: US 2014/0311640 A1
(43) Pub. Date: Oct. 23, 2014

(54) PNEUMATIC TIRE

(71) Applicant: TOYO TIRE & RUBBER CO., LTD., Osaka (JP)

(72) Inventor: Souichi Takahashi, Osaka-shi (JP)

(73) Assignee: TOYO TIRE & RUBBER CO., LTD., Osaka (JP)

(21) Appl. No.: 14/256,203

(22) Filed: Apr. 18, 2014

(30) Foreign Application Priority Data
Apr. 23, 2013 (JP) 2013-090414

(51) Int. Cl. B60C 11/13

(52) U.S. Cl. CPC B60C 11/1376
USPC 152/209.15

(57) ABSTRACT

A pneumatic tire is provided with a center land section formed between center main grooves, a pair of intermediate land sections formed between shoulder main grooves and the center main grooves, and a pair of shoulder land sections formed on the outside of the shoulder main grooves in a tire width direction. The center land section and the intermediate land sections swell outwardly in a tire radial direction from a basic tread profile line that smoothly connects ground contact surfaces of the pair of shoulder land sections. The radius of a peak section of the intermediate land sections is equal to or smaller than the radius of a peak section of the center land section, and the thickness of the intermediate land sections is greater than the thickness of the center land section.

### BACKGROUND OF THE INVENTION

1. Field of the Invention

The present invention relates to a pneumatic tire.

2. Background Art

Performances such as an operation stability performance and a high fuel efficiency are demanded in a pneumatic tire. In order to improve these performances, a variety of techniques have been proposed.

For example, JP-A-2007-69665 discloses a pneumatic tire in which a center portion of a tread section swells outwardly in a tire radial direction. This pneumatic tire employs a tire profile in which only the center portion of the thread section is in contact with the ground under a low load such as normal traveling.

JP-A-2005-263180 discloses a pneumatic tire including a tread section provided with plural circumferential main grooves that extend in a tire circumferential direction and a rib formed between the circumferential main grooves, in which the rib swells outwardly in a radial direction from an arc-shaped contour line L of a radius R passing through a front surface of a shoulder rib.

Further, JP-A-2005-319890 discloses a pneumatic tire including a tread section provided with a pair of main grooves that continuously extends in a tire circumferential direction on both sides of a tire equator and a center rib that is continuous in the tire circumferential direction and is formed between the pair of main grooves, in which the center rib swells outwardly in a tire radial direction from a virtual tread profile line that smoothly connects tread surfaces including both ground contact ends except for the center rib.

Further, JP-A-62-241709 discloses a pneumatic tire in which a tread section is divided in a width direction into five regions of a pair of outer regions, a central region and a pair of intermediate regions disposed between the outer regions and the central region, by plural main grooves that extend in a circumferential direction, and a protruding section that swells outwardly in a radial direction is provided in the intermediate region.

### SUMMARY OF THE INVENTION

However, if the center portion of the tread section in the tire width direction swells outwardly in the tire radial direction as disclosed in JP-A-2007-69665, JP-A-2005-263180, and JP-A-2005-319890, there is a problem in that the operation stability is enhanced by enlargement of a ground contact area, but a around contact length of the center portion in the tire width direction becomes relatively large compared with the other sections, and thus, the rolling resistance increases.

Further, if only the intermediate regions disposed between the outer regions and the central region of the tread section swell outward in the tire radial direction as disclosed in JP-A-62-241709, there is a problem in that only the intermediate sections are in contact with the ground under a low load, and thus, a ground contact area decreases, which deteriorates the operation stability.

An object of the invention is to provide a pneumatic tire capable of achieving a high fuel efficiency and a high operation stability performance.

According to an aspect of the invention, there is provided a pneumatic tire including a tread section that is provided with: a pair of center main grooves that extends in a tire circumferential direction; a pair of shoulder main grooves that is provided on the outside of the pair of center main grooves in a tire width direction and extends in the tire circumferential direction; a center land section that is formed between the pair of center main grooves; a pair of intermediate land sections that is formed between the shoulder main grooves and the center main grooves; and a pair of shoulder land sections that is formed on the outside of the pair of shoulder main grooves in the tire width direction, in which in a state where the pneumatic tire is filled with a regulated internal pressure, the center land section and the intermediate land sections swell outwardly in a tire radial direction from a basic tread profile line that smoothly connects ground contact surfaces of the pair of shoulder land sections, and the thickness of the intermediate land sections is greater than the thickness of the center land section and the radius of a peak section of the intermediate land sections is equal to or smaller than the radius of a peak section of the center land section.

According to a preferable aspect of the invention, in the pneumatic tire according to the above aspect of the invention, a swelling amount of the center land section from the basic tread profile line may be 0.3 mm or more to 1.0 mm or less. According to another preferable aspect of the invention, in the pneumatic tire according to the above aspects of the invention, a difference between the radius of the peak section of the center land section and the radius of the peak section of the intermediate land sections maybe 0 mm or more to 0.5 mm or less.

According to the invention, in a state where the pneumatic tire is filled with a regulated internal pressure, as the thickness of the intermediate land sections is greater than the thickness of the center land section and the radius of a peak section of the intermediate land sections is equal to or smaller than the radius of a peak section of the center land section, it is possible to increase the ground contact area of the center land section and the intermediate land sections, and to enhance operation stability. Further, as the ground contact lengths of the center land section and the intermediate land sections are approximately equal to each other, it is possible to reduce a rolling resistance. Thus, it is possible to achieve a high fuel efficiency and a high operation stability performance.

### BRIEF DESCRIPTION OF THE DRAWINGS

FIG. 1 is a half-cross-sectional view illustrating a pneumatic tire according to a first embodiment.

FIG. 2 is a development view illustrating a tread pattern of the pneumatic tire according to the first embodiment.

FIG. 3 is an enlarged view of a section of FIG. 1, which is an enlarged cross-sectional view illustrating a main part of a tread section.

### DETAILED DESCRIPTION OF THE INVENTION

Hereinafter, embodiments of the invention will be described with reference to the accompanying drawings.

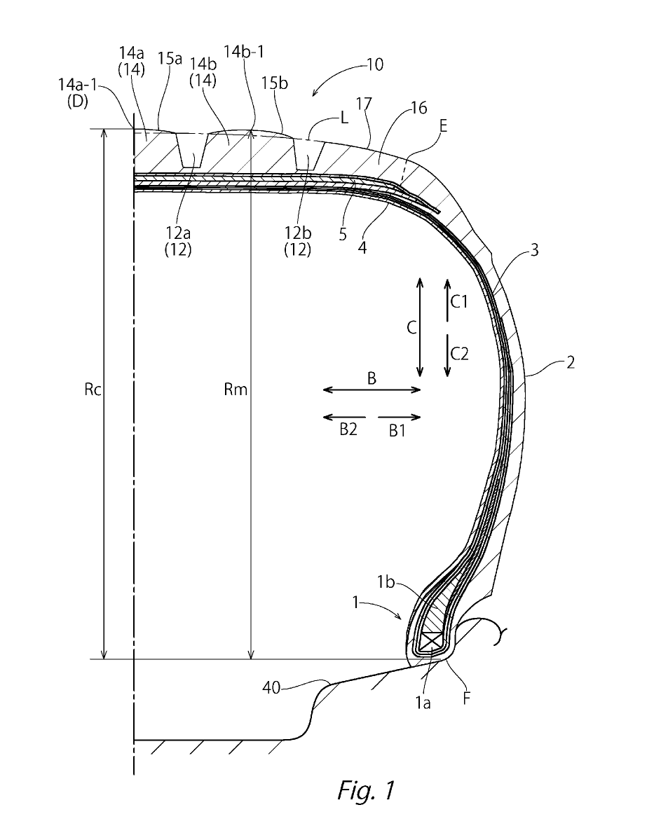

FIG. 1 is a half-cross-sectional view illustrating a pneumatic tire according to an embodiment of the invention, seen in a tread width direction, which shows a state where the pneumatic tire is mounted in a rim 40 and is filled with a regulated internal pressure.

The pneumatic tire is a radial tire that includes a pair of right and left bead sections 1, a pair of right and left side wall sections 2 that extends from the respective right and left bead sections 1 toward the outside C1 in a tire radial direction, a tread section 10 connected to an outer peripheral end of each of the right and left side wall sections 2, and a carcass 3 arranged to be stretched between the pair of bead sections 1.

In the bead section 1, an annular bead core 1a in which a bundle of steel wires or the like are covered with rubber, and a bead filler 1b of a triangular cross-section disposed on the outside C1 in the tire radial direction with reference to the bead core 1a are embedded.

The carcass 3 is wound so that the bead core 1a and the bead filler 1b are inserted therein, and its end portion is locked to the bead core 1a and the bead filler 1b. An inner liner 4 for maintaining an air pressure is disposed inside the carcass 3.

A belt 5 that includes two or more layers of rubber-covered steel code layers is provided on an outer circumferential side of the carcass 3 in the tread section 10. The belt 5 reinforces the tread section 10 on the outer circumferential side of the carcass 3.

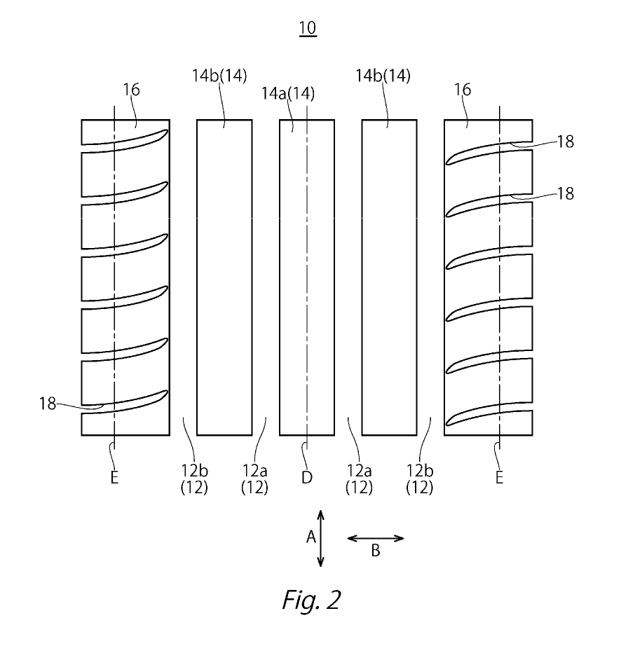

As shown in FIG. 2, on a surface of the tread section 10, four main grooves 12 that extend along a tire circumferential direction A are provided. Specifically, the main grooves 12 include a pair of center main grooves 12a disposed on both sides with a tire equator D being interposed therebetween, and a pair of shoulder main grooves 12b that are provided on the outside B1 in the tire width direction with reference to the pair of center main grooves 12a.

In the tread section 10, due to the four main grooves 12, a center land section 14a is formed between the two center main grooves 12a, intermediate land sections 14b are formed between the center main grooves 12a and the shoulder main grooves 12b, and shoulder land sections 16 are formed on the outside B1 of the two shoulder main grooves 12b in the tire width direction.

In the shoulder land section 16, plural transverse grooves 18 that extend in a direction intersecting with the tire circumferential direction A are provided in the tire circumferential direction A at predetermined intervals. The transverse grooves 18 extend toward the outside B1 in the tire width direction over a tread ground contact end E from the inside B2 in the tire width direction with reference to the tread ground contact end E. The transverse grooves 18 are opened toward a tread side edge, and are terminated in the shoulder land section 16 so as not to be opened toward the shoulder main groove 12b.

As shown in FIG. 2, the center land section 14a and the intermediate land sections 14b are continuous in the tire circumferential direction A without being divided in the tire circumferential direction A. In the shoulder land section 16, the plural transverse grooves 18 that extend in the direction intersecting with the tire circumferential direction A are provided in the tire circumferential direction A at the predetermined intervals. The center land section 14a and the intermediate land sections 14b may form a block row in which plural blocks divided by transverse grooves are arranged in the tire circumferential direction A, and the shoulder land sections 16 may be continuous in the tire circumferential direction A without being divided in the tire circumferential direction A.

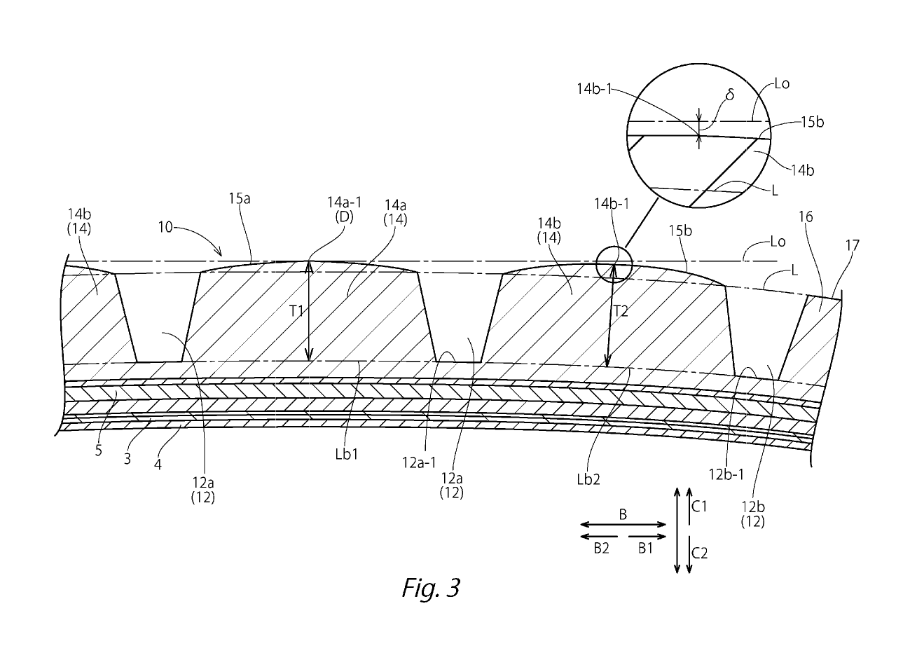

As shown in FIGS. 1 and 3, the center land section 14a and the intermediate land sections 14b swell toward the outside C1 in the tire radial direction from a basic tread profile line L.

More specifically, the basic tread profile line L is a curve that is obtained by connecting plural arcs between tangent points having a common tangential line and smoothly connects ground surfaces 17 of the pair of shoulder land sections 16 in a state where the tire as shown in FIG. 1 filled with a regulated internal pressure. The center land section 14a and the intermediate land sections 14b swell toward the outside C1 in the tire radial direction from the basic tread profile line L so that a center portion thereof in the width direction B protrudes to the maximum. Thus, ground contact surfaces 15a and 15b of the center land section 14a and the intermediate land sections 14b form an arc shape in which peak sections 14a-1 and 14b-1 are positioned at center portions thereof in the width direction B.

In the center land section 14a and the intermediate land sections 14b in which the ground contact surfaces 15a and 15b are curved in the arc shape as described above, in the state where the tire is filled with the regulated internal pressure, the radius of the peak section 14b-1 of the intermediate land sections 14b (a length obtained by adding a rim diameter to a height Rm in the tire radial direction C from a bead heel F to the peak section 14b-1 of the intermediate land sections 14b, that is, a distance from the peak section 14b-1 to a tire rotational axis) is set to be equal to or smaller than the radius of the peak section 14a-1 of the center land section 14a (a length obtained by adding the rim diameter to a height Rc in the tire radial direction C from the bead heel F to the peak section 14a-1 of the center land section 14a, that is, a distance from the peak section 14a-1 to the tire rotational axis). In other words, the peak section 14b-1 of the intermediate land sections 14b does not protrude toward the outside C1 in the tire radial direction from an outer diameter reference line Lo that passes through the peak section 14a-1 of the center land section 14a and extends in the tire width direction B, and is positioned on the outer diameter reference line Lo or on the inside C2 in the tire radial direction from the outer diameter reference line Lo (see FIG. 3).

Further, the center land section 14a and the intermediate land sections 14b are provided so that a thickness T2 of the intermediate land sections 14b is greater than a thickness T1 of the center land section 14a. Here, in this specification, the thickness T1 of the center land section 14a corresponds to a distance from a line Lb1 that passes through a groove bottom 12a-1 of one center main groove 12a having a greater groove depth among the two center main grooves 12a that form the center land section 14a and is parallel with the basic tread profile line L to the peak section 14a-1 of the center land section 14a, and the thickness T2 of the intermediate land section 14b corresponds to a distance from a line Lb2 that passes through a groove bottom of one main groove having a greater groove depth among the center main groove 12a and the shoulder main groove 12b that form the intermediate land section 14b and is parallel with the basic tread profile line L to the peak section 14b-1 of the intermediate land section 14b.

As shown in FIG. 3, when the groove depths of the two center main grooves 12a that form the center land section 14a are the same, the line Lb1 passes through the groove bottoms 12a-1 of the two center main grooves 12a. In this case, the line Lb1 may be formed to be close to a straight line that connects the groove bottoms 12a-1 of the two center main grooves 12a to determine the thickness T1 of the center land section 14a.

Further, when the groove depths of the center main groove 12a and the shoulder main groove 12b that form the intermediate land section 14b are the same, the line Lb2 passes through the groove bottom 12a-1 of the center main groove 12a and the groove bottom 12b-1 of the shoulder main groove 12b. in this case, the line Lb2 may be formed to be close to a straight line that connects the groove bottom 12a-1 of the center main groove 12a and the groove bottom 12b-1 of the shoulder main groove 12b to determine the thickness T2 of the intermediate land section 14b.

Amounts (swelling amounts) where the center land section 14a and the intermediate land sections 14b swell toward the outside C1 in the tire radial direction from the basic tread profile line L are not particularly limited as long as the radius of the peak section 14b-1 of the intermediate land sections 14b is equal to or smaller than the radius of the peak section 14a-1 of the center land section 14a and the thickness T2 of the intermediate land section 14b is greater than the thickness T1 of the center land section 14a. For example, if the swelling amount of the center land section 14a is excessively small, a ground contact area is reduced to deteriorate the operation stability. Further, if the swelling amount of the center land section 14a is excessively large, a ground contact length of the center portion in the tire width direction is increased to increase a rolling resistance. For this reason, it is preferable that the swelling amount of the center land section 14a be set to 0.3 mm or more to 1.0 mm or less.

Further, if the radius of the peak section 14b-1 of the intermediate land sections 14b is greater than the radius of the peak section 14a-1 of the center land section 14 (that is, if the height Rm is greater than the height Rc in FIG. 1), only the intermediate land sections 14b come into contact with the ground under a low load to reduce the ground contact area, thereby deteriorating the operation stability. On the other hand, if a difference δ between the radius of the peak section 14a-1 of the center land section 14a and the radius of the peak section 14b-1 of the intermediate land sections 14b (that is, a difference (Rc−Rm) between the height Rc and the height Rm in FIG. 1) is excessively large, the ground contact length of the center portion in the tire width direction is greater than those of the other portions to increase the rolling resistance. For this reason, it is preferable that the height difference δ be set to 0 mm or more to 0.5 mm or less.

Further, in the present embodiment, in order to prevent deterioration of the rolling resistance due to a non-uniform ground contact pressure distribution of the center land section 14a and the intermediate land sections 14b, it preferable that the peak sections 14a-1 and 14b-1 that swell the most toward the outside C1 in the radial direction in the center land section 14a and the intermediate land sections 14b be respectively in the range of 30% of the total widths of the ground contact surfaces 15a and 15b with reference to the centers of the ground contact surfaces 15a and 15b in the tire width direction B.

In the pneumatic tire of the above-described embodiment, in the state where the tire is filled with the regulated internal pressure, the thickness T2 of the intermediate land sections 14b is set to be greater than the thickness T1 of the center land section 14a and the radius of the peak section 14b-1 of the intermediate land sections 14b is set to be equal to or smaller than the radius of the peak section 14a-1 of the center land section 14a. Thus, it is possible to increase the ground contact area in the center land section 14a and the intermediate land sections 14b while uniformly maintaining the ground contact length of the center land section 14a and the intermediate land sections 14b, and to achieve a high fuel efficiency and a high operation stability performance.

### EXAMPLES

Hereinafter, examples of the invention will be more specifically described, but the invention is not limited to the examples.

Pneumatic radial tires (195/65R15) for passenger cars of Examples 1 and 2 and Comparative Examples to 3 were manufactured for a test.

The respective tires were the same in a basic tread pattern and a tire inner structure, and were manufactured by changing the respective specifications shown in Table 1.

Specifically, Examples and 2 are examples of a pneumatic tire in which the center land section 14a and the intermediate land sections 14b swell outwardly from the basic tread profile line L so that the thickness T2 of the intermediate land sections 14b is greater than the thickness T1 of the center land section 14a and the radius of the peak section 14b-1 of the intermediate land sections 14b is equal to or smaller than the radius of the peak section 14a-1 of the center land section 14a (that is, the height difference δ (=Rc−Rm) between the center land section 14a and the intermediate land sections 14b is 0 or greater).

Comparative Example 1 is an example of a pneumatic tire in which the center land section 14a and the intermediate land sections 14b do not swell from the basic tread profile line L. Comparative Example 2 is an example of a pneumatic tire in which the center land section 14a and the intermediate land sections 14b swell from the basic tread profile line L but the thickness T2 of the intermediate land sections 14b is smaller than the thickness T1 of the center land section 14a.

Comparative Example 3 is an example of a pneumatic tire in which the center land section 14a and the intermediate land sections 14b swell from the basic tread profile line L so that the thickness T2 of the intermediate land sections 14b is greater than the thickness T1 of the center land section 14a but the radius of the peak section 14b-1 of the intermediate land sections 14b is greater than the radius of the peak section 14a-1 of the center land section 14a (that is, the height difference δ (=Rc−Rm) between the center land section 14a and the intermediate land sections 14b is smaller than 0).

A cornering power (operation stability) and a rolling resistance performance (high fuel efficiency) of each pneumatic tire of Examples 1 and 2 and Comparative Examples 1 to 3 was evaluated. An evaluation method is as follows.
Cornering power: A cornering force generated in a test tire under a low load (45% of the JATMA-defined maximum load) was measured using a drum tester of the diameter of 2500 mm, and a cornering power at a slip angle of 1° was obtained. Index evaluation was performed with an index of the result of Comparative Example 1 being set to 100. Here, as a numerical value of the index is large, the cornering power increases, and the operation stability performance is superior.
Rolling resistance: A rolling resistance of the tire under the low load (45% of the JATMA-defined maximum load) under the condition of a tire inner pressure of 200 kPa, a rim size of 15×6 JJ, a load of 4.2 kN and a speed of 80 Km/h was measured using a rolling resistance tester. Indexes are shown with an index of Comparative Example 1 being set to 100. Here, as the index is small, the rolling resistance decreases, and the fuel efficiency is superior.

TABLE 1

| | Example | Example | Comparative | Comparative | Comparative |
|---|---|---|---|---|---|
| | 1 | 2 | Example 1 | Example 2 | Example 3 |
| Thickness T1 (mm) of center | 8.3 | 8.3 | — | 8.5 | 8.3 |
| land section | | | | | |
| Thickness T2 (mm) of | 8.5 | 8.7 | — | 8.3 | 9.0 |
| intermediate land sections | | | | | |
| Height difference δ (mm) | 0.3 | 0.1 | — | 0.7 | −0.2 |
| between center land section and | | | | | |
| intermediate land sections | | | | | |
| Cornering power | 105 | 104 | 100 | 102 | 96 |
| Rolling resistance | 100 | 101 | 100 | 105 | 102 |

The result is shown in Table 1. In Comparative Example 2 in which the thickness T2 of the intermediate land sections 14b is smaller than the thickness T1 of the center land section 14a, compared with Comparative Example 1, the cornering power under the low load was improved and the operation stability was improved, whereas the rolling resistance under the low load increased and the fuel efficiency deteriorated.

Further, in Comparative Example 3 in which the radius of the peak section 14b-1 of the intermediate land sections 14b is greater than the radius of the peak section 14a-1 of the center land section 14a, compared with Comparative Example 1, the cornering power and the rolling resistance under the low load deteriorated, and thus, the operation stability performance and the fuel efficiency deteriorated.

On the other hand, in Examples 1 and 2 in which the center land section 14a and the intermediate land sections 14b swell outwardly from the basic tread profile line L so that the thickness T2 of the intermediate land sections 14b is greater than the thickness T1 of the center land section 14a and the radius of the peak section 14b-1 of the intermediate land sections 14b is equal to or smaller than the radius of the peak section 14a-1 of the center land section 14a, with respect to Comparative Example 1, the cornering power under the low load was improved, and thus, the operation stability was improved. Further, in Examples 1 and 2, compared with Comparative Examples 2 and 3 in which the center land section 14a and the intermediate land sections 14b swell outward from the basic tread line L, the rolling resistance under the low load was decreased, and even though the center land section 14a and the intermediate land sections 14b swell outwardly from the basic tread line L, it was possible to improve the operation stability while suppressing deterioration of the fuel efficiency under the low load.

1. A pneumatic tire comprising a tread section that is provided with:
a pair of center main grooves that extends in a tire circumferential direction;
a pair of shoulder main grooves that is provided on the outside of the pair of center main grooves in a tire width direction and extends in the tire circumferential direction;
a center land section that is formed between the pair of center main grooves;
a pair of intermediate land sections that is formed between the shoulder main grooves and the center main grooves; and
a pair of shoulder land sections that is formed on the outside of the pair of shoulder main grooves in the tire width direction,
wherein in a state where the pneumatic tire is filled with a regulated internal pressure, the center land section and the intermediate land sections swell outwardly in a tire radial direction from a basic tread profile line that smoothly connects ground contact surfaces of the pair of shoulder land sections, and
wherein the radius of a peak section of the intermediate land sections is equal to or smaller than the radius of a peak section of the center land section and the thickness of the intermediate land sections is greater than the thickness of the center land section.

2. The pneumatic tire according to claim 1,
wherein a swelling amount of the center land section from the basic tread profile line is 0.3 mm or more to 1.0 mm or less.

3. The pneumatic tire according to claim 1,
wherein a difference between the radius of the peak section of the center land section and the radius of the peak section of the intermediate land sections is 0 mm or more to 0.5 mm or less.

4. The pneumatic tire according to claim 2,
wherein a difference between the radius of the peak section of the center land section and the radius of the peak section of the intermediate land sections is 0 mm or more to 0.5 mm or less.
